(19) United States
(12) Patent Application Publication
(10) Pub. No.: US 2018/0288224 A1
(43) Pub. Date: Oct. 4, 2018

(54) PRIORITIZING INCOMING EMERGENCY CALLS RECEIVED FROM A PLURALITY OF CLIENT DEVICES

(71) Applicant: Carbyne Ltd., Tel-Aviv (IL)

(72) Inventors: Alexander DIZENGOF, Tel Aviv (IL); Amir ELICHAI, Tel Aviv (IL)

(21) Appl. No.: 15/937,928

(22) Filed: Mar. 28, 2018

Related U.S. Application Data
(60) Provisional application No. 62/477,537, filed on Mar. 28, 2017.

(51) Int. Cl. H04M 3/51; H04W 4/90; H04W 76/50

(52) U.S. Cl. CPC H04M 3/5116; G06F 3/0481; H04W 76/50; H04W 4/90

(57) ABSTRACT

A computer implemented method of prioritizing incoming emergency calls at a dispatch center, comprising using one or more processors for detecting one or more incoming emergency calls from one or more client devices, before accepting each of the incoming emergency call(s), acquiring via a communication network, sensory data captured by one or more sensors associated with the respective client device and monitoring an environment of the respective client device, automatically analyzing the sensory data to identify one or more environment parameters deduced from the analysis, prioritizing one or more of the incoming emergency calls in a queue comprising a plurality of incoming emergency calls concurrently received from a plurality of client devices according to the environment parameter(s) and adjusting a graphical user interface (GUI) presented on a display of one or more dispatch center client terminals according to the prioritization.

### RELATED APPLICATIONS

This application claims the benefit of priority under 35 USC § 119(e) of U.S. Provisional Patent Application No. 62/477,537, filed on Mar. 28, 2017. The contents of the above application are all incorporated by reference as if fully set forth herein in their entirety.

### BACKGROUND

The present invention, in some embodiments thereof, relates to automatically prioritizing incoming emergency calls at an emergency dispatch center, and, more specifically, but not exclusively, to automatically prioritizing incoming emergency calls at an emergency dispatch center based on analysis of sensory data acquired from originating client devices.

One of the key factors in handling emergency events is traced to the ability of emergency dispatch centers, for example, Public Safety Answering Points (PSAP), police dispatch centers, medical services dispatch centers, fire department dispatch centers and/or the like to quickly respond to incoming emergency calls received from reporters of the emergency events.

Such emergency dispatch centers are typically manned by trained dispatchers which are able to briefly interrogate the reporter and asses the emergency event to decide on a course of action, a response type, an emergency service(s) to be alerted and/or the like.

However, no matter how professional these dispatchers may be, the response time to accepting and handling the incoming emergency calls may often be significantly high due to the limited number of dispatchers required to accept and serve potentially very high numbers of incoming emergency calls.

### SUMMARY

According to a first aspect of the present invention there is provided a computer implemented method of prioritizing incoming emergency calls at a dispatch center, comprising using one or more processors for:
Detecting one or more incoming emergency calls from one or more client devices.
Before accepting one or more of the incoming emergency calls, acquiring via a communication network, sensory data captured by one or more sensors associated with the respective client device and monitoring an environment of the respective client device.
Automatically analyzing the sensory data to identify one or more environment parameters deduced from the analysis.
Prioritizing one or more of the incoming emergency calls in a queue comprising a plurality of incoming emergency calls concurrently received from a plurality of client devices according to the environment parameter(s).
Adjusting a graphical user interface (GUI) presented on a display of one or more dispatch center client terminals according to the prioritization.

According to a second aspect of the present invention there is provided a system for prioritizing incoming emergency calls at a dispatch center, comprising:
A program store storing a code.
One or more processors coupled to the program store for executing the stored code. The code comprising:
   Code instructions to detect one or more incoming emergency calls from one or more client devices.
   Code instructions to, before accepting one or more of the incoming emergency calls, acquire via a communication network, sensory data captured by one or more sensors associated with the respective client device and monitoring an environment of the respective client device.
   Code instructions to automatically analyze the sensory data to identify one or more environment parameters deduced from the analysis.
   Code instructions to prioritize one or more of the incoming emergency calls in a queue comprising a plurality of incoming emergency calls concurrently received from a plurality of client devices according to the environment parameter(s).
   Code instructions to adjust a GUI presented on a display of one or more dispatch center client terminals according to the prioritization.

At any given time the emergency dispatch center may receive an extremely high number of incoming emergency calls which may not be immediately accepted (served) due to limited personal resources, i.e. trained dispatchers. By automatically analyzing the sensory data acquired from the originating client devices, potential emergency events reported by the incoming emergency calls may be automatically evaluated to estimate their severity and/or urgency before the incoming emergency calls are accepted and prioritizing the respective incoming emergency calls accordingly. The prioritized incoming emergency calls may be queued and presented the dispatcher(s) thus significantly improving the response time to the reporter(s) (who initiated the incoming emergency call(s)) and significantly improving handling, assisting and/or taking any other appropriate action in response to the reported emergency event.

According to a third aspect of the present invention there is provided a computer implemented method of generating a unified digital dashboard presented on a display of one or more dispatch center client terminals, comprising using at least one processor for:
Receiving a plurality of sensory data sets from a plurality of client devices from which a plurality of incoming emergency calls is received. Each of the plurality of sensory data sets comprises multimedia content consisting of at least imagery data, video data and/or audio data captured by one or more sensors associated with a respective one of the plurality of client devices.
Generating a unified digital dashboard comprising one or more widgets created for one or more of the plurality of incoming emergency calls. Each of the widget(s) presenting the multimedia content received from a respective client device from which the one or more incoming emergency calls are received.
Adjusting a graphical user interface (GUI) presented on a display of one or more dispatch center client terminals to present the unified digital dashboard.

Generating the unified digital dashboard comprising the widget(s) may significantly improve visibility of the incoming emergency calls to the dispatcher(s) and may provide the dispatcher(s) with easy and/or immediate access to information (e.g. the sensory data, the multimedia content, the identification information, etc.). This may significantly improve the ability of the dispatcher(s) to understand (grasp) the emergency event, its nature, severity, implications and/or the like thus further reduce the response time and/or improve the response provided by the dispatcher(s).

In a further implementation form of the first and/or second aspects, each of the environment parameters is a member of a group consisting of: a parameter related to the one or more client devices, a parameter related to a user of the one or more client devices, a parameter related to interaction between the user and the one or more client devices and a parameter related to a surroundings of the one or more client devices. Determining the environment parameters relating to major aspects of the potential emergency event, i.e. the reporter, the client device, the characteristics of each potential emergency event, i.e. type, nature and/or the like may allow an accurate evaluation of the severity, criticality and urgency of each of the potential emergency events in order to prioritize the respective incoming emergency events accordingly.

In a further implementation form of the first and/or second aspects, each of the one or more sensors is a member of a group consisting of: an imaging sensor, an audio sensor, a geolocation sensor, a motion sensor, a physical condition sensor monitoring a user of the one or more client devices and/or the like. Using sensory data collected from a wide range of sensors may allow creating a comprehensive sensory data base which may be used to determine, identify and evaluate the environment parameters which in turn may allow an accurate evaluation of the of the severity, criticality and urgency of the potential emergency.

In a further implementation form of the first and/or second aspects, one or more of the sensors are integrated in the one or more client device. Taking advantage of sensors readily available in the client device to capture the sensory data used to evaluate the potential emergency event may significantly reduce the effort, cost and/or resources needed to adopt the prioritization system for prioritizing the plurality of incoming emergency calls since the need for specially deployed sensors may be avoided.

In a further implementation form of the first and/or second aspects, one or more of the sensors are integrated one or more another peripheral devices associated with a user of the one or more client devices and operatively communicating with the one or more client devices through one or more communication channels. Taking advantage of sensors available other devices associated with the user (reporter), in particular wearable devices to capture the sensory data may significantly expand the sensory data base to include additional data that is may not be directly available from the client device itself. The extended sensory data base may allow for a significantly improved identification of the environment parameters and hence a significantly improved evaluation of the potential emergency event. In addition using sensors available from the peripheral devices may further reduce the effort, cost and/or resources needed to adopt the prioritization system.

In an optional implementation form of the first and/or second aspects, the sensory data is continuously collected from the one or more sensors and stored by the one or more client devices regardless of initiation of the one or more incoming emergency calls. Sensory data which is continuously captured, collected and stored regardless of initiation of emergency call from the client device, may allow access to sensory data captured prior to initiation of the emergency call. In many cases such data depicting the reporter, the client device and/or the surroundings of the client device prior to the call initiation may have significant value in understanding and/or responding to potential emergency event(s).

In an optional implementation form of the first and/or second aspects, one or more of the environment parameters are identified by one or more of the client devices. Identifying the environment parameters locally at the client device may significantly reduce the computing load and/or computing time at a central prioritization system thus significantly improving the time for evaluating and estimating the potential emergency event(s) and hence reducing the response time.

In an optional implementation form of the first and/or second aspects, the prioritization is done according to identification data acquired from the one or more client devices in conjunction with the sensory data, the identification data comprising one or more members of a group consisting of: an age of a user of the one or more client devices, a gender of the user, a name of the user, a telephone number associated with the at last one client device and an indication of a destination of the one or more incoming emergency calls. The identification information of the user (reporter) may be a major factor in estimating a potential emergency event and therefore prioritizing the incoming emergency call(s) according to the identification information may significantly improve the assessment of the severity and/or urgency of the potential emergency event(s).

In an optional implementation form of the first and/or second aspects, the prioritization is done based on comparison of at least some of the identification data with stored identification data collected during one or more previous emergency calls. By comparing the identification data relating to current incoming emergency calls to identification data relating to previous (past) incoming emergency calls may provide some insight(s) with respect to the reporter, with respect to the geographical area in which the reporter is currently located and/or the like, for example, a geographical location known to suffer frequent emergency events, a reporter known to be fraudulent and/or the like. Considering such insights may further improve the prioritization process.

In an optional implementation form of the first and/or second aspects, the prioritization is done according to a prioritization model mapping a value of the one or more environment parameters to an emergency condition urgency level based on an analysis of a plurality of previous incoming emergency calls with respect to the one or more environment parameters associated with each of the plurality of previous incoming emergency. Using one or more prioritization models, for example, models created using machine learning algorithm(s) may significantly improve estimation and/or evaluation of the potential emergency event based on information acquired by analyzing previous incoming emergency calls with respect to the emergency events reported by these previous incoming emergency calls.

In a further implementation form of the first and/or second aspects, the GUI is adjusted to present the queue in an order defined by the prioritization. Adjusting the GUI to reflect the prioritized queue may significantly improve visibility of the prioritized queue of incoming emergency calls to the dispatcher(s) who may respond to the incoming emergency calls according to their assigned priority.

In a further implementation form of the first and/or second aspects, the GUI is adjusted to accentuate one or more visual indications associated with one or more of the incoming emergency calls according to the prioritization. Accentuating, for example, enlarging, highlighting, marking and/or the like of visual indications associated with high priority incoming emergency calls may significantly improve visibility and/or perception of the dispatcher(s) to notice the high priority incoming emergency calls thus reducing the probability that such high priority incoming emergency calls are left unnoticed and hence not served and/or improving the response time since the dispatcher(s) may attend sooner to such high priority calls.

In a further implementation form of the first and/or second aspects, the GUI to present one or more widgets associated with the one or more incoming emergency calls, the one or more widgets comprising a representation of at least some of the sensory data associated with the one or more incoming emergency calls and identification data acquired from the one or more client devices. The widget(s) may provide the dispatcher(s) easy and/or immediate access to information (e.g. the sensory data, the multimedia content, the identification information, etc.) thus significantly improving the ability of the dispatcher(s) to understand (grasp) the emergency event, its nature, severity, implications and/or the like thus further reducing the response time and/or improving the response provided by the dispatcher(s).

In an optional implementation form of the first and/or second aspects, the GUI is adjusted to present a unified digital dashboard comprising the one or more widgets. The unified digital dashboard comprising the widget(s) may significantly improve visibility of the prioritized queue of incoming emergency calls by the dispatcher(s) who may respond to the incoming emergency calls according to their assigned priority.

In an optional implementation form of the first and/or second aspects, the GUI is adjusted present the unified digital dashboard comprising a plurality of widgets associated with at least some of the plurality of incoming emergency calls. Presenting the plurality of widgets corresponding to the plurality of incoming emergency calls may allow the dispatcher(s) to get a broader understanding of the queued incoming emergency calls and possibly their priority in the queue to better plan response and/or handling to these incoming emergency calls. The dispatcher(s) may further access information, for example, sensory data, identification data and/or the like relating to one or more incoming emergency calls while responding and/or accepting another incoming emergency call.

In an optional implementation form of the first and/or second aspects, the GUI is maintained to present one or more of the widget after the respective one or more incoming emergency calls are accepted. It may be desirable to have fast and easy access to information relating to one or more incoming emergency calls even after accepting, forwarding and/or responding to the incoming emergency call(s). For example, the dispatcher may further interrogate a reporter who was already served to get additional information and/or to assist emergency personnel on route and/or on site of the reported emergency event.

In an optional implementation form of the first and/or second aspects, a subset of the plurality of incoming emergency calls is correlated together according to a geolocation identified for each of the incoming emergency calls of the subset based on the analysis of the sensory data acquired from the respective client devices. This may also allow analyzing sensory data collected from a plurality of client devices capturing aspects, and/or elements of the emergency event from multiple different viewpoints.

In an optional implementation form of the first and/or second aspects, the GUI is adjusted to present the correlation between a plurality of visual indications each associated with a respective incoming emergency call of the subset. Adjusting the GUI presentation to correlate between multiple incoming emergency calls potentially relating to the same emergency event may improve the ability of the dispatcher(s) to respond to these incoming emergency calls and avoid individually responding to each of these incoming emergency calls.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of automatically prioritizing incoming emergency calls at an emergency dispatch center, according to some embodiments of the present invention;

FIG. 2A and FIG. 2B are schematic illustrations of exemplary embodiments of a system for automatically prioritizing incoming emergency calls at an emergency dispatch center, according to some embodiments of the present invention; and

FIG. 3 is a schematic illustration of an exemplary unified digital dashboard Graphical User Interface (GUI) presented on a display of an emergency dispatch center client terminal, according to some embodiments of the present invention.

### DETAILED DESCRIPTION

The present invention, in some embodiments thereof, relates to automatically prioritizing incoming emergency calls at an emergency dispatch center, and, more specifically, but not exclusively, to automatically prioritizing incoming emergency calls at an emergency dispatch center based on analysis of sensory data acquired from originating client devices.

According to some embodiments of the present invention, there are provided methods and systems for automatically prioritizing incoming emergency calls at an emergency dispatch center, for example, a PSAP and/or the like based on one or more environment parameters identified by analyzing sensory data captured by sensors monitoring and/or depicting the environment of the client devices. Based on the environment parameter(s) a severity and/or urgency of potential emergency events may be evaluated and prioritized according to one or more priority rules. The potential emergency events may include, for example, an accident, a medical emergency a potential crime (e.g. a terror attack, a car theft, a burglary, a fight, a murder, a kidnap, a sexual harassment and/or attack, etc.) a public disorder (e.g. a strike, a vandalism act, etc.) and/or the like.

One or more incoming emergency calls may be received from one or more client devices, for example, a cellular phone, a Smartphone, a tablet, a laptop and/or the like each used by a respective user (reporter) to report of one or more potential emergency events. The incoming emergency calls are detected by analyzing the incoming call, for example, determining that the dialed number of the incoming call is associated with an emergency service, for example, the police, a medical service, the fire department and/or the like.

Once an incoming call is detected as an incoming emergency call and before accepting it (by a human dispatcher), the incoming emergency call may be directed to an incoming emergency calls processing system, for example, a server, a cloud service and/or the like which may establish a communication session with the originating client device to acquire sensory data collected by the originating client device. The incoming emergency call may be identified by one or more Private Branch Exchanges (PBX) executing a PBX agent (e.g. an application, service, etc.) adapted to identify the incoming emergency calls among a plurality of received calls. Optionally, in particular in case one or more of the incoming emergency call is a Voice over Internet Protocol (VoIP) call which may include data, the sensory data and/or part thereof is included in the respective incoming emergency call. The incoming emergency calls may be identified using a Dialed Number Identification Service (DNIS) and/or the like to determine whether an incoming call is directed to an emergency service.

The sensory data may be captured by one or more sensors associated with the originating client device. The sensors may monitor and/or depict an environment of the originating client device. The sensors may be integrated in the originating client device and/or included in one or more peripheral devices which are operatively communicating with the originating client device, for example, a wearable device and/or the like. The sensory data may relate to the client device itself, to the user of the client device (reporter) and/or to the surroundings of the client device and may include, for example, imagery data (images, video, etc.), audio data (sound, voice, speech, noise, etc.), motion data, geolocation data, physical condition data of the reporter (e.g. heartbeat rate, blood pressure, respiration rate, temperature, perspiration level, etc.), interaction data reflecting interaction between the reporter and the originating client device and/or the like.

The incoming emergency calls processing system may analyze the sensory data acquired from the originating client device to identify one or more environment parameters relating to the client device, to the reporter and/or to the surroundings of the client device. The environment parameter(s) deduced from the analysis may be indicative of the type, nature, severity and/or urgency of a respective potential emergency event that the reporter attempts to report about by initiating the emergency call. The incoming emergency calls processing system may further base the analysis on identification data (information) acquired from the originating client device, for example, an age of the reporter, a gender of the reporter, a name of the reporter, a telephone number associated with the client device, an indication of a destination number to which the respective incoming emergency call is directed (i.e. the emergency service the reporter attempts to contact) and/or the like.

Based on the environment parameter(s) and optionally on the identification data, the incoming emergency calls processing system may evaluate the nature, severity and/or urgency of the potential emergency events estimated for the incoming emergency calls. The incoming emergency calls processing system may then prioritize one or more of the incoming emergency calls in a queue comprising a plurality of incoming emergency calls which are waiting to be accepted by one or more dispatchers trained to briefly interrogate the reporter(s) and according to one or more priority rules based on the type, nature, severity, criticality and/or urgency of the estimated potential emergency event(s).

Optionally, the incoming emergency calls processing system correlates between groups of multiple incoming emergency calls received from multiple client devices and possibly relating to the same potential emergency event. For example, based on the location of the geographical location estimated for a group of originating client devices from which the incoming emergency calls are received, the incoming emergency calls processing system may identify that the group of client devices located in close proximity to each other. The incoming emergency calls processing system may therefore analyze the sensory data acquired from at least some of the group of client devices to identify the environment parameter(s) and more accurately evaluate the potential emergency event.

Optionally, the incoming emergency calls processing system analyzes sensory data captured prior to the initiation of the emergency call and acquired from the originating client device in case such sensory data is available. This may allow the incoming emergency calls processing system to identify and/or estimate one or more environment parameters relating to a time proceeding the time when the reporter initiated the emergency call.

Optionally, the incoming emergency calls processing system prioritizes one or more of the incoming emergency calls based on previous incoming emergency calls. The information relating to the previous incoming emergency calls may be stored in one or more local storage resources and/or remote storage resources accessible via a network. For example, assuming an incoming emergency call is received from a client device identified as located in an area in known (based on previous emergency calls) to have a high crime rate, the incoming emergency calls processing system may assign a higher priority to such an incoming emergency call.

The incoming emergency calls processing system may further adjust and/or instruct of adjustment of a Graphical User Interface (GUI) presented on a display of one or more dispatch center client terminals used by the dispatcher(s) according to the prioritization of the queue. For example, the GUI may be adjusted to accentuate presentation of incoming emergency calls assigned with a higher priority indicating higher severity, requiring immediate response and/or the like.

The dispatcher(s) may then accept the incoming emergency calls according to their location in the prioritized queue as presented by the GUI on the display of the dispatch center client terminal(s).

According to some embodiments of the present invention, the incoming emergency calls processing system may generate a unified digital dashboard presentation comprising visual indications, for example, widgets created for one or more of the queued incoming emergency calls and adjust the GUI to present the unified dashboard. Each widget may present and/or include a link to the sensory data acquired for the respective incoming emergency call, for example, multimedia content such as, for example, video stream(s), image(s), audio stream(s) and/or the like. The widget may further include textual content, for example, a telephone number of the originating client device, a geographical location and/or an address of the originating client device, a name of the reporter of the potential emergency event and/or the like. Using the GUI, for example, interacting with the widget(s), the dispatcher(s) may access information relating to each of the potential emergency events estimated for each of the incoming emergency calls, for example, the multimedia content and/or the textual content.

Automatically prioritizing incoming emergency calls for acceptance by trained dispatchers at an emergency dispatch center may present significant advantages and benefits compared to current systems and methods for accepting incoming emergency calls.

First, at any given time the emergency dispatch center may receive an extremely high number of incoming emergency calls which may not be immediately accepted (served) due to limited personal resources, i.e. trained dispatchers. Currently existing methods may typically use a first in first out (FIFO) method in which the first to call is generally the first to be served. This may naturally present a major limitation since incoming emergency calls relating to higher severity emergency events and/or emergency events requiring immediate response may be left unserved while emergency calls relating to lesser emergency events may be served first. By automatically analyzing the sensory data acquired from the originating client devices, the incoming emergency calls processing system may evaluate the severity and urgency of each of the potential emergency events before the incoming emergency calls are accepted and prioritize the respective incoming emergency calls accordingly. This may significantly improve the response time of the dispatcher(s) to the reporter(s) and significantly improve handling, assisting and/or taking any other appropriate action in response to the reported emergency event.

Moreover, generating the widget(s) and optionally the unified digital dashboard may significantly improve visibility of the prioritized queue of incoming emergency calls to the dispatcher(s) who may respond to the incoming emergency calls according to their assigned priority. Furthermore, the widget(s) and the unified digital dashboard may provide the dispatcher(s) easy and/or immediate access to information (e.g. the sensory data, the multimedia content, the identification data, etc.). This may significantly improve the ability of the dispatcher(s) to understand (grasp) the emergency event, its nature, severity, implications and/or the like thus further reduce the response time and/or improve the response provided by the dispatcher(s).

Furthermore, correlating between multiple incoming emergency calls potentially relating to the same emergency event may further improve the ability to respond to these incoming emergency calls and avoiding individually responding to each of these incoming emergency calls. This may also allow analyzing sensory data collected from a plurality of client devices capturing aspects, and/or elements of the emergency event from multiple different viewpoints thus further improving the ability of the dispatcher(s) to understand the emergency event, its nature, severity, implications and/or the like thus further reduce the response time and/or improve the response provided by the dispatcher(s).

In addition, analyzing sensory data captured prior to the reporter initiating the emergency call may further improve ability of the dispatcher(s) to understand the emergency event, specifically actions, events and/or the like which occurred before the reporter initiated the incoming emergency call. This may further improve the response provided by the dispatcher(s) since the dispatcher(s) may identify additional aspects which occurred before the reporter initiated the incoming emergency call but may have severe implications on the actions and/or response that needs to be taken to handle the emergency event.

Adopting, integrating and deploying the incoming emergency calls processing system in existing emergency dispatch centers may be very simple and straight forward since only the PBX agent needs to be deployed on PBX(s) already available at the existing emergency dispatch centers. The PBX agent adapted to identify the incoming emergency calls among the plurality of incoming calls may forward the incoming emergency calls to the incoming emergency calls processing system. The time, cost and/or effort required to deploy the incoming emergency calls processing system may therefore be significantly low making the incoming emergency calls processing system an attractive solution to significantly improve the operation of the emergency dispatch center(s) and reduce their response time to the incoming emergency calls while improving the response time and/or accuracy.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer Program code comprising computer readable program instructions embodied on a computer readable medium may be transmitted using any appropriate medium, including but not limited to wireless, wire line, optical fiber cable, RF, etc., or any suitable combination of the foregoing.

The program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code can be downloaded to respective computing/processing devices from a computer readable storage medium or to an external computer or external storage device via a network, for example, the Internet, a local area network, a wide area network and/or a wireless network.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

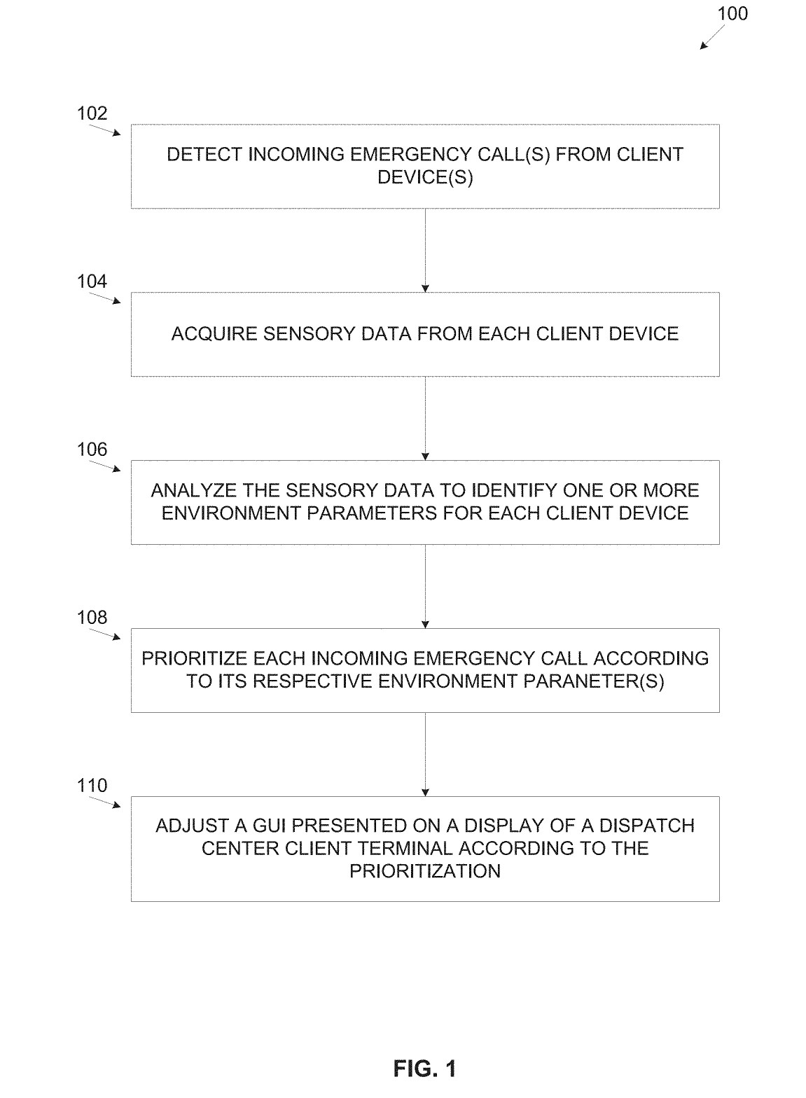

Referring now to the drawings, FIG. 1 illustrates a flowchart of an exemplary process of automatically prioritizing incoming emergency calls at an emergency dispatch center, according to some embodiments of the present invention. A process 100 may be executed for prioritizing incoming emergency calls received from a plurality of client devices based on one or more environment parameters identified by analyzing sensory data captured by sensors monitoring and/or depicting the environment of the client devices to evaluate a severity and/or urgency of potential emergency events.

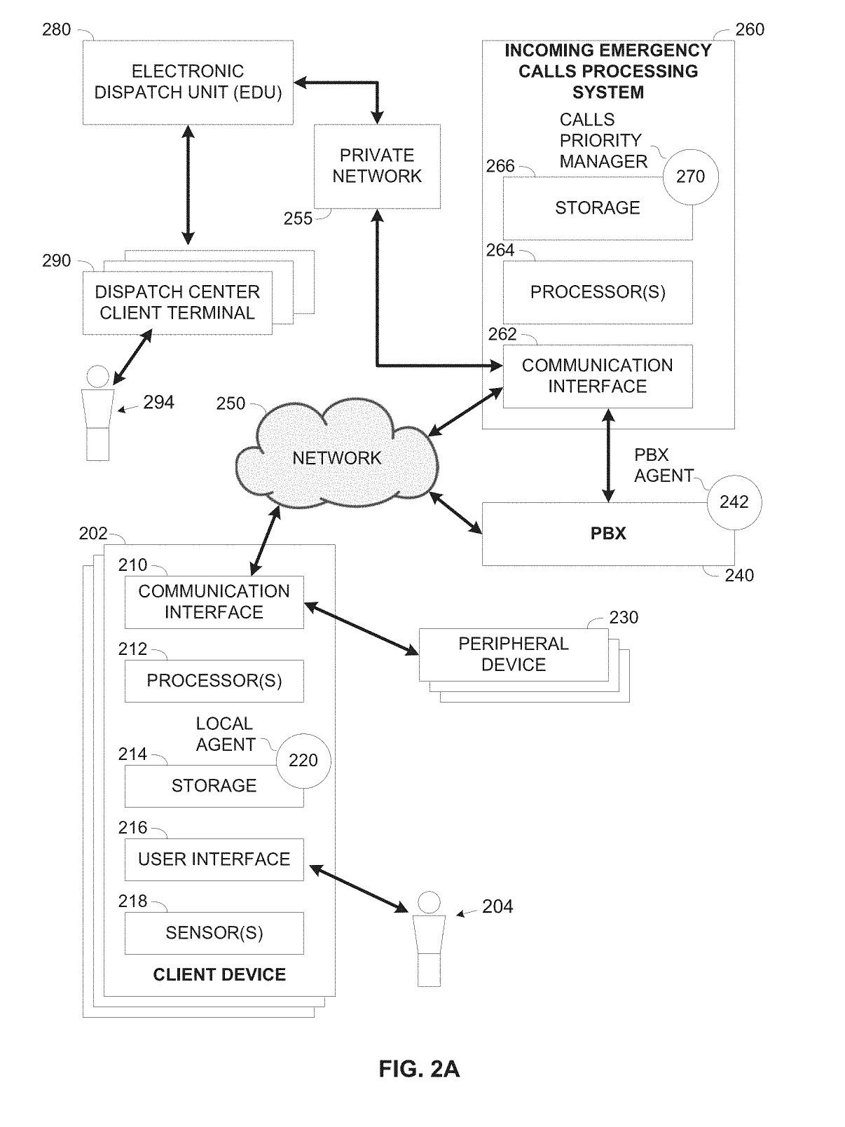

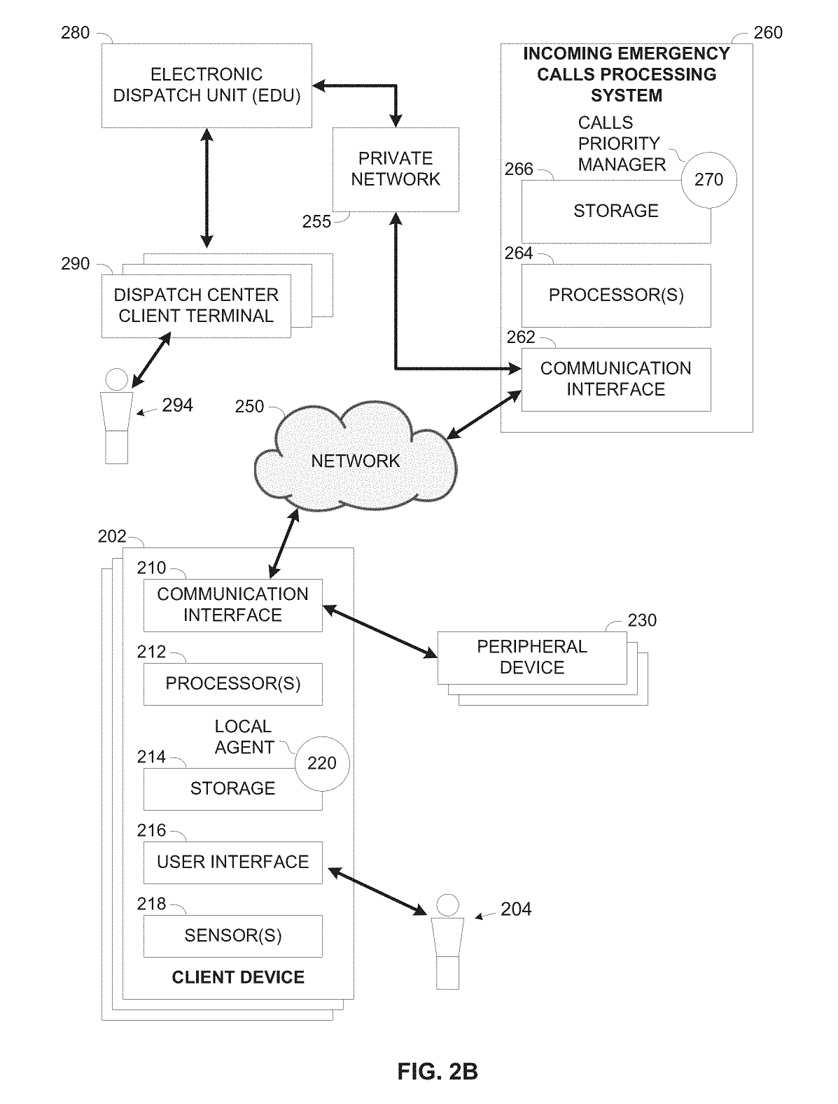

Reference is also made to FIG. 2A and FIG. 2B, which are schematic illustrations of exemplary embodiments of a system for automatically prioritizing incoming emergency calls at an emergency dispatch center, according to some embodiments of the present invention. As shown in FIG. 2A and FIG. 2B, one or more client devices 202, for example, a Smartphone, a tablet, a laptop and/or the like may be used by one or more users (reporters) 204 to report of one or more potential emergency events by initiating emergency calls to an incoming emergency calls processing system 260 adapted to execute a process such as the process 100 for prioritizing the incoming emergency calls.

Emergency Dispatch Units (EDU) 280 adapted to receive incoming emergency calls via the network 250 and direct them to one or more dispatch center client terminals 290 used by one or more dispatchers 294 trained to accept incoming emergency calls and take one or more actions based on a brief interrogation of the reporter(s) 204.

The client device 202 may include a communication interface 210, a processor(s) 212 for executing a process such as the process 100 and storage 214 for storing program code (thus the storage 214 serves as a program store) and/or data.

The communication interface 212 may include one or more wired and/or wireless network interfaces for connecting to a network 250 comprising one or more networks, for example, a Local area Network (LAN), a Wireless LAN (WLAN), a Wide Area Network (WAN), a Municipal Area Network (MAN), a telephone network, a cellular network, the internet and/or the like. The processor(s) 212, homogenous or heterogeneous, may include one or more processing nodes arranged for parallel processing, as clusters and/or as one or more multi core processor(s). The storage 214 may include one or more non-transitory memory devices, either persistent non-volatile devices, for example, a Read Only Memory (ROM), a Flash array, a hard drive, a solid state drive (SSD), a magnetic disk and/or the like and/or one or more volatile devices, for example, a Random Access Memory (RAM) device, a cache memory and/or the like.

The client device 202 may also include a user interface 216 comprising one or more human machine interfaces for interacting with the reporter 204, for example, a keyboard, a pointing device, a display, a touchscreen, a speaker, a microphone, a tactile interface and/or the like. Using the user interface 216, the reporter 204 may interact and operate the client device 202.

The client device 202 may further include one or more sensors 218, for example, an imaging sensor (e.g. a camera, a night vision sensor, an infrared sensor, etc.), an audio sensor (e.g. a microphone, etc.), a motion sensor (e.g. an accelerometer, a gyroscope, etc.), a geolocation sensor (e.g. a GPS sensor, etc.) a tactile sensor and/or the like.

The communication interface 210 may further include one or more wired and/or wireless communication channels, for example, Bluetooth, WLAN (e.g. Wi-Fi), Universal Serial Bus (USB), Near Field Communication (NFC) and/or the like for connecting to one or more peripheral devices 230, for example, a wearable device such as, for example, a smart watch, a smart bracelet, an earphone, an activity tracker, a fitness device, a wearable imaging device (e.g. a camera), a wearable audio sensor (e.g. a microphone) and/or the like.

One or more of the peripheral devices 230 operatively communicating with the client device 202 may include one or more sensors, for example, the imaging sensor, the audio sensor, the geolocation sensor, the motion sensor, a physical condition sensor monitoring the physical condition signs (e.g. pulse, blood pressure, respiration rate, perspiration level, temperature, etc.) of the reporter 204 and/or the like.

The processor(s) 212 may execute one or more software modules, for example, a process, a script, an application, an agent, a utility, a tool and/or the like each comprising a plurality of program instructions stored in a non-transitory medium such as the storage 214 and executed by one or more processors such as the processor(s) 212. For example, the processor(s) 212 may execute a local agent 220 to collect sensory data from the sensors 216 and/or from the peripheral device(s) 230 and to communicate with an incoming emergency calls processing system 260 adapted to execute a process such as the process 100 for prioritizing incoming emergency calls.

In some embodiments of the present invention, as shown in FIG. 2A, the emergency call(s) initiated by the client device(s) 202 are directed to one or more PBXs 240, specifically, PBX(s) associated with one or more emergency dispatch centers, for example, a Public Safety Answering Point (PSAP), a police dispatch, a medical dispatch, a fire department dispatch and/or the like. In such embodiments one or more incoming emergency calls may be initiated by one or more of the client devices 202 as voice calls directed trough the network 250 to the PBX(s) 240. The PBX 240 is adapted to receive a plurality of incoming calls from the client device 202 and direct the incoming calls to their destination(s). Moreover, the PBX 240 may execute a PBX agent 242 adapted to identify one or more incoming emergency calls among the plurality of incoming calls and direct the identified incoming emergency call(s) to the incoming emergency calls processing system 260.

The incoming emergency calls processing system 260, for example, a server, a computing node, a cluster of computing nodes and/or the like is adapted to execute a process such as the process 100 for prioritizing incoming emergency calls received from one or more of the plurality of client devices 202. The incoming emergency calls processing system 260 may include a communication interface 262 such as the communication interface 202 for connecting to the network 250, a processor(s) 264 such as the processor(s) 212 and storage 266 such as the storage 214. The storage 266 may further comprise one or more network storage devices, for example, a storage server, a network accessible storage (NAS), a network drive, and/or the like. The storage 266 may be further utilized through one or more remote storage resource, for example, a database, a cloud storage and/or the like accessible via the network 250.

The processor(s) 264 may execute one or more software modules, for example, a calls priority manager 270 to execute the process 100, specifically to acquire the sensory data from the client device(s) 202, analyze the sensory data and prioritize incoming emergency calls received from one or more of the client devices based on one or more environment parameters deduced from the analysis.

In some embodiments of the present invention, as shown in FIG. 2B, one or more incoming emergency calls initiated by one or more of the client device 202 are directly received from by the incoming emergency calls processing system 260 via the network 250. In such embodiments one or more incoming emergency calls may be initiated by one or more of the client devices 202 as Voice over Internet Protocol (VoIP) calls which may be directed through the network 250 to the incoming emergency calls processing system 260.

Optionally, the incoming emergency calls processing system 260 and/or the calls priority manager 270 executed by the incoming emergency calls processing system 260 are implemented as one or more cloud computing services, for example, Infrastructure as a Service (IaaS), Platform as a Service (PaaS), Software as a Service (SaaS) and/or the like such as, for example, Amazon Web Service (AWS), Google Cloud, Microsoft Azure and/or the like.

The incoming emergency calls processing system 260 may direct the incoming emergency call(s) to one or more Emergency Dispatch Units (EDU) 280 adapted to receive incoming emergency calls and direct them to one or more dispatch center client terminals 290 used by one or more dispatchers 294 trained to accept incoming emergency calls and take one or more actions based on a brief interrogation of the reporter(s) 204. Typically the incoming emergency calls processing system 260 may transfers the incoming emergency call(s) to the EDU(s) 280 through a private network 255, for example, an intranet and/or the like which may be highly immune against external cyber threats, for example, data interception, domain attacks, malicious message or call injection and/or the like. However, in some embodiments the incoming emergency calls processing system 260 may transfers the incoming emergency call(s) to the EDU(s) 280 through the network 250. In such cases, the transferred data and calls may be encrypted.

As shown at 102, the process 100 starts with the calls priority manager 270 detecting one or more incoming emergency calls received from one or more originating client devices 202.

In case the incoming emergency calls are received from the PBX 240 as shown in FIG. 2A, the calls priority manager 270 may detect any incoming call as an incoming emergency call since the PBX agent 242 executed by the PBX 240 may identify the incoming emergency calls among other incoming calls and detect only the incoming emergency calls to the incoming emergency calls processing system 260. In case the incoming calls are directly routed to the incoming emergency calls processing system 260 as shown in FIG. 2B, the calls priority manager 270 itself detects incoming emergency calls among other received incoming calls. The calls priority manager 270 and/or the PBX agent 242 may identify incoming calls as incoming emergency call(s) by checking the dialed number used for the incoming call, for example, the identifier provided by one or more services such as DNIS and/or the like. In case the dialed number is associated with an emergency service, for example, the police, a medical service, the fire department and/or the like, the calls priority manager 270 and/or the PBX agent 242 may determine the respective incoming call as an emergency call.

Optionally, the local agent 220 is used to initiate one or more of the emergency calls which are eventually directed to the calls priority manager 270. The local agent may support initiating and establishing outgoing calls over one or more protocols, for example, a standard (regular) voice call, a VoIP call and/or the like. The local agent 220 may further support establishing one or more one way and/or two way data delivery sessions, multimedia transfer and/or the like over one or more links and/or networks available by the respective client device 202.

As shown at 104, after detecting an incoming emergency call and before accepting it, the calls priority manager 270 may establish a communication session with the originating client device 202 which initiated the incoming emergency call, specifically with the local agent 220 executed by the originating client device 202 in order to acquire sensory data from the originating client device 202. The calls priority manager 270 may identify the originating client device 202 by analyzing the Automatic Number Identification (ANI) extracted from the incoming emergency call. Using the ANI of the originating client device 202, the calls priority manager 270 may obtain an address, for example, an IP address and/or the like of the originating client device 202 and establish a data communication session with the local agent 220.

After establishing the communication session with the originating client device 202, the calls priority manager 270 may acquire sensory data collected by the local agent 220.

In some embodiments, in particular, in case one or more of the incoming emergency calls are VoIP calls issued by the local agent(s) 220 and directly received by the calls priority manager 270 at the incoming emergency calls processing system 260, the incoming emergency call may already include the sensory data and/or part thereof. To support such cases, the calls priority manager 270 may be adapted to extract the sensory data from the incoming emergency call(s).

The local agent 220 may collect the sensory data from one or more sensors such as the sensor(s) 218 integrated in the originating client device 202 and/or the sensor(s) integrated in the peripheral device(s) 230 which may communicate with the originating client device 202 through one or more of the communication channels provided by the communication interface 210.

Based on the type, features, characteristics and/or capabilities of the sensor(s) 218 and/or the sensors available in the peripheral device(s) 230, the sensory data collected by the local agent 220 may include a plurality of sensory data items such as, for example:
Imagery data comprising, for example, images, video and/or the like depicting the originating client device 202, the reporter 204 using the originating client device 202, the surrounding environment of the originating client device 202 and the reporter 204, other people in proximity to the originating client device 202 and/or the like.
Audio data comprising, for example, sound, voice, noise and/or the like captured at the surrounding environment of the originating client device 202, for example, sound and/or voice of the reporter 204, sound, speech and/or voice of other people, objects and/or events in the surrounding environment and/or the like.
Geolocation data comprising, for example, a geographical location of the originating client device 202, geographical coordinates of the current location of the originating client device 202 an address of the current location of the originating client device 202 and/or the like.
Motion data comprising, for example, motion of the originating client device 202, motion of the reporter 204 and/or the like.
Physical condition data reflecting physical condition signs of the reporter 204, for example, pulse (heartbeat rate), blood pressure, respiration rate, temperature, perspiration level and/or the like.
Interaction data reflecting interaction between the reporter 204 and the originating client device 202, for example, keyboard strokes speed, keyboard strokes accuracy and/or the like.

The calls priority manager 270 may further acquire identification data from the local agent 220. The identification data may include personal details of the respective reporter 204, identification data of the originating client device 202 and/or the like. The identification data may include, for example, an age of the reporter 204, a gender of the reporter 204, a name of the reporter 204, a telephone number associated with the originating client device 202 and/or the like.

The personal details of the reporter 204 may be readily available to the local agent 220 from the storage of the originating client device 202, for example, from the storage 214. For example, the personal details may be stored in the storage 216 during the setup and/or registration for the local agent 220 when the reporter 204 may provide his personal details to the local agent 220 which may store the personal details in the storage 214. In another example, the local agent 220 may obtain the personal details of the reporter 204 from one or more services and/or application available at the client device 202, for example, a user account, an information service and/or the like. In order to maintain privacy, the local agent 220 may optionally request, during the setup process and/or on the first launch, the reporter 204 to allow the local agent 220 to access such services and/or applications. As it has access to the stored personal details, the local agent 220 may relief the reporter 204 from the need to insert and/or provide his personal details in real time, i.e. during an emergency event, an operation which may be time consuming and therefore may present a major obstacle during the emergency event.

Typically, the local agent 220 may start collecting the sensory data in response to the request of the calls priority manager 270 to establish the communication session for acquiring the sensory data. In case the sensory data is provided to the calls priority manager 270 as part of the emergency call, the sensory data may include real-time sensory data collected by the local agent 220 during the time of initiating the emergency call. However, the local agent 220 may continuously and/or periodically collect the sensory data and/or part thereof regardless of the emergency call initiation and/or regardless of any reported event. The local agent 220 may store the collected sensory data, for example, in the storage 214. In such case, at the time of initiating the emergency call and/or while communicating with the calls priority manager 270, the local agent 220 may provide sensory data collected prior to the initiation of the emergency call.

As shown at 106, the calls priority manager 270 analyzes the sensory data to identify one or more environment parameters relating to a potential emergency event the reporter 204 attempts to report by initiating the emergency call. The environment parameters may include one or more parameters relating to, for example, the originating client device 202, the reporter 204, an interaction between the reporter 204 and the originating client device 202, surroundings of the originating client device 202 and/or the like.

The environment parameters relating to the originating client device 202 may include, for example, a location of the originating client device 202 identified by analyzing the geolocation data available in the sensory data.

The environment parameters relating to the reporter 204 may include, for example, a respiration rate of the reporter 204 identified by analyzing, for example, audio data available in the sensory data. The inhale and/or exhale sounds of the reporter 204 breathing may be analyzed to identify the respiration rate. Additionally and/or alternatively, the respiration rate of the reporter 204 may be identified by analyzing respiration rate readings available in the physical condition data which may be captured, for example, by a sensor integrated in one or more of the peripheral devices 230. In another example, the environment parameters relating to the reporter 204 may include the pulse (heartbeat rate) of the reporter 204 identified by analyzing pulse readings available in the physical condition data which may be captured, for example, by a sensor integrated in one or more of the peripheral devices 230, for example, a smart bracelet, a fitness bracelet and/or the like.

The environment parameters relating to the interaction between the reporter 204 and the originating client device 202 may include, for example, a motion of the originating client device 202 identified by analyzing the motion data available in the sensory data. The motion may be indicative of actions of the reporter 204, for example, walking, running, jumping, struggling and/or the like. In another example, environment parameters relating to the interaction between the reporter 204 and the originating client device 202 may include a keyboard strokes speed, frequency, accuracy and/or the like identified by analyzing the interaction data available in the sensory data.

The environment parameters relating to the surroundings of the originating client device 202 may include, for example, identification of an emergency event, for example, an accident, a medical emergency a potential crime (e.g. a terror attack, a car theft, a burglary, a fight, a murder, a kidnap, a sexual harassment and/or attack, etc.) a public disorder (e.g. a strike, a vandalism act, etc.) and/or the like. The calls priority manager 270 may identify such emergency events by analyzing one or more data items available in the sensory data, for example, an image, a video stream, a sound, a voice, a speech and/or the like which are captured by the sensor(s) 218 and or the sensors of the peripheral device(s) 230 depicting the surroundings of the originating client device 202. For example, the calls priority manager 270 may identify gun fire by analyzing the audio sensory data. In another example, the calls priority manager 270 may identify a fire, a car accident, car theft event, a terror attack and/or the like by analyzing the image(s) and/or the video stream. In another example, the calls priority manager 270 may identify one or more persons involved in a car theft event, a terror attack and/or the like by analyzing the image(s) and/or the video stream. Analyzing the image(s) and/or the video stream, and optionally the audio data, the calls priority manager 270 may further identify a location, a path, a runaway direction and/or the like of one or more persons involved in the car theft event, a terror attack and/or the like.

Optionally, the calls priority manager 270 analyzes sensory data captured prior to the initiation of the emergency call by the originating client device 202 in case such sensory data is available. This may allow the calls priority manager 270 to identify and/or estimate one or more environment parameters relating to a time proceeding the time when the reporter 204 initiated the emergency call.

Optionally, one or more of the originating client devices 202, specifically the respective local agent(s) 220 analyze their respective sensory data to identify one or more of the environment parameters relating to a potential emergency event the reporter 204 attempts to report by initiating the emergency call. The local agent(s) 220 may apply the same methods, techniques and/or algorithms as done buy the calls priority manager 270 to identify the environment parameter(s). In such case, the calls priority manager 270 may acquire the environment parameter(s) from the respective local agent(s) 220 and uses the acquired environment parameter(s) to estimate the respective potential emergency event the reporter 204 wishes to report.

Based on the identified and/or estimated environment parameter(s), the calls priority manager 270 estimates the potential emergency event the reporter 204 attempts to report of and one or more characteristics of the estimated potential emergency event. For example, based on the identified environment parameter(s), the calls priority manager 270 estimates the potential emergency event as a car accident with multiple injuries at a certain location. In another example, the calls priority manager 270 estimates the potential emergency event as a burglary in progress to a house where the reporter 204 is currently located. Based on the physical conditions environment parameter(s) relating to the reporter 204, the calls priority manager 270 may further detect that the reporter 204 is under major stress.

Optionally, the calls priority manager 270 applies one or more machine learning methods, techniques and/or algorithms to classify the identified environment parameters to respective potential emergency events. For example, using the machine learning algorithm(s) applied to the environment parameter(s), for example, gun fire, people screams, identified weapon(s) and/or the like, the calls priority manager 270 may estimate a certain potential emergency event as a terror attack. In another example, using the machine learning algorithm(s) applied to the environment parameter(s), for example, a car wreck, cries for help from a wounded person(s) and/or the like, the calls priority manager 270 may estimate a certain potential emergency event as a car accident with injured person(s).

Optionally, the calls priority manager 270 correlates together one or more subsets of incoming emergency calls received from multiple client devices 202 and possibly relating to the same potential emergency event. For example, based on the location environment parameter(s) identified and/or estimated for a subset of originating client devices 202 from which incoming emergency calls are received, the calls priority manager 270 may identify that the subset of client devices 202 is located in close proximity to each other. The calls priority manager 270 may therefore analyze the sensory data acquired from at least some of the subset of client devices 202 to identify the environment parameters and more accurately evaluate the potential emergency event and/or its characteristic(s).

As shown at 108, the calls priority manager 270 prioritizes one or more of the incoming emergency calls in a queue of incoming emergency calls according to the respective emergency event and/or its characteristics estimated based on analysis of the environment parameter(s) identified for each incoming emergency call. The calls priority manager 270 may prioritize the incoming emergency call(s) according to one or more priority rules defining prioritization of the potential emergency events estimated for the corresponding incoming emergency calls.

For example, based on one or more of the priority rules, the calls priority manager 270 may assign a high priority to incoming emergency calls corresponding to higher severity emergency events, for example, emergency events in which life is at risk, for example, a fire, a kidnap, a car accident and/or the like. In contrast, based on one or more of the priority rules, the calls priority manager 270 may assign a low priority to incoming emergency calls corresponding to potential emergency events of lesser consequences, for example, public property vandalism, a car accident with no injuries, a lost pet and/or the like. In another example, based on one or more of the priority rules, the calls priority manager 270 may assign a high priority to incoming emergency calls corresponding to emergency events which are in progress, for example, a fire, a car theft, a kidnap and/or the like. In contrast, based on one or more of the priority rules, the calls priority manager 270 may assign a low priority to incoming emergency calls corresponding to potential emergency events which ended, for example, a bank robbery where the robbers already left the area and/or the like.

The calls priority manager 270 may further use the identification data if available for prioritizing the potential emergency event and/or its characteristic(s). For example, assuming two incoming emergency calls are received, where for both emergency calls, the calls priority manager 270 estimates the potential emergency event as a stalking event. Further assuming, based on the identification data, the calls priority manager 270 identifies that the reporter 204 of the first emergency call is a 24 year old woman and the reporter 204 of the second emergency call is a 35 year old man. In such case, according to one or more of the priority rules, the calls priority manager 270 may assign a higher priority to the first emergency call since for the same stalking event the 24 year old woman may be in greater risk than the 53 year old man.

Optionally, the calls priority manager 270 prioritizes one or more of the incoming emergency calls based on previous incoming emergency calls received from one or more client devices 202 and/or from one or more reporters 204. The information relating to the previous incoming emergency calls may be stored in one or more store resources, for example, the storage 262 and/or the remote storage resources accessible via the network 250, i.e. the database, the cloud storage and/or the like. The calls priority manager 270 may further use a prioritization model which maps a value of the one or more environment parameters to an emergency condition urgency and/or severity level based on an analysis of a plurality of previous incoming emergency calls with respect to the one or more environment parameters associated with a respective one of a plurality of emergency events reported by each of the plurality of previous incoming emergency. The model may be created using the machine learning methods, techniques and/or algorithms which may classify the identified environment parameters to respective potential emergency events based on analysis of training datasets and/or actual incoming emergency calls which are analyzed compare to the actual emergency event reported by these incoming emergency calls.

For example, assuming a certain incoming emergency call is received from a certain client device 202 having a certain ANI. Further assuming that based on analysis of records of previous incoming emergency calls, the calls priority manager 270 identifies that several incoming emergency calls which were received in the past from the same certain client device 202 were found to be fraudulent calls. In such case the calls priority manager 270 may assign a lower priority to the certain incoming emergency call. In another example, assuming a certain incoming emergency call is received from a certain client device 202 located at a certain geographical location. Further assuming that based on analysis of records of previous incoming emergency calls, the calls priority manager 270 identifies that multiple emergency events were reported in the past for the geographical location. In such case the calls priority manager 270 may assign a higher priority to the certain incoming emergency call.

As shown in 110, the calls priority manager 270 may adjust and/or instruct an adjustment of a GUI presented on a display of one or more of the dispatch center client terminals 290 used by the dispatcher(s) 294 to display the queue of incoming emergency calls according to the prioritization of the queue. The calls priority manager 270 may communicate with the EDU 280 via the private network 255 (or in some embodiments through the network 250) to provide an adjusted GUI and/or to instruct the EDU 280 to adjust the GUI presented by one or more of the dispatch center client terminals 290. For example, the GUI may be adjusted to accentuate, for example, enlarging, highlighting, marking and/or the like presentation of one or more visual indications associated with one or more incoming emergency calls having higher priority. Accentuating the visual indication(s) associated with high priority incoming emergency call(s) may significantly improve visibility and/or perception of the dispatcher(s) to notice the high priority incoming emergency calls. This accentuation may reduce the probability that high priority incoming emergency calls are left unnoticed and hence not served. The accentuation may also improve the response time since the dispatcher(s) 294 may attend sooner to the high priority incoming emergency call(s).

The dispatcher(s) 294 may then accept the incoming emergency calls according to their location in the prioritized queue as presented by the GUI on the display of the dispatch center client terminal(s) 290.

According to some embodiments of the present invention the GUI includes one or more widgets generated by and/or according to instructions of the calls priority manager 270 for one or more of the incoming emergency calls. The widget may present information relating to the associated incoming emergency call, for example, the sensory data, the identification data, an indication of a destination number and/or emergency center to which the associated incoming emergency call is directed and/or the like. For example, the widget may present multimedia content available from the sensory data comprising one or more items, for example, a live video stream, an image, a live audio stream, a recorded video stream, a recorded audio stream and/or the like. The widget may present textual content, for example, the geographical location and/or the address of the originating client device 202, the ANI of the originating client device 202, the name of the reporter 204, the age of the reporter 204, the gender of the reporter 204 and/or the like. The widget may further present a map with an indication of the geolocation of the originating client device 202.

Optionally, the calls priority manager 270 adjusts one or more widgets to present a subset of one or more correlated incoming emergency calls estimated by the calls priority manager 270 to relate to the same potential emergency event.

Moreover, the calls priority manager 270 may generate and/or instruct the EDU 280 and/or the dispatch center client terminal(s) 290 to generate a unified digital dashboard presentation comprising visual indications of the queued incoming emergency calls, for example, a plurality of widgets each associated with a respective one of the plurality of incoming emergency calls. The calls priority manager 270 may generate the unified digital dashboard to reflect the prioritized queue such that widgets created for higher priority incoming emergency calls are accentuated, for example, placed at the top of the unified digital dashboard, highlighted with a certain color (e.g. red), enlarged with respect to other widgets and/or the like.

Optionally, the calls priority manager 270 adjusts the unified digital dashboard to correlate multiple widgets created for a subset of one or more correlated incoming emergency calls estimated by the calls priority manager 270 to relate to the same potential emergency event.

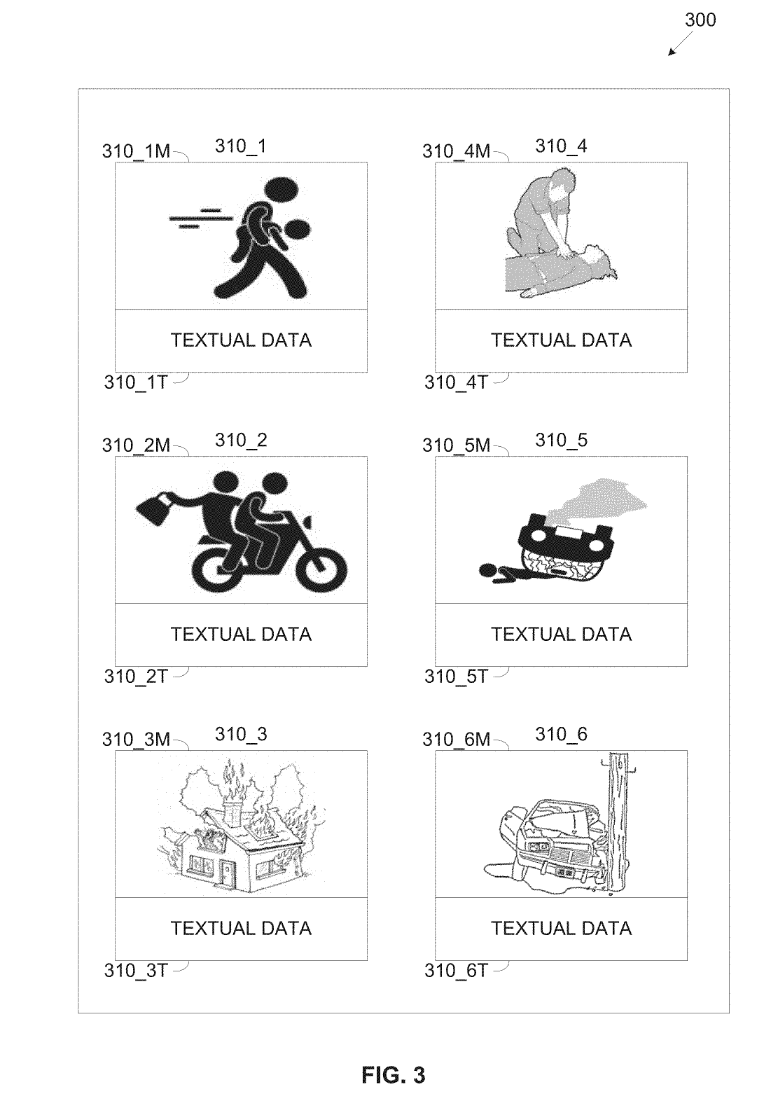

Reference is now made to FIG. 3, which is a schematic illustration of an exemplary unified digital dashboard GUI presented on a display of an emergency dispatch center client terminal, according to some embodiments of the present invention. An exemplary unified digital dashboard 300 may be presented on a display of one or more dispatch center client terminals such as the dispatch center client terminal 290. The unified digital dashboard 300 comprises several widgets 310 each associated with a respective one of a plurality of incoming emergency calls each corresponding to a respective potential emergency event as estimated by a calls priority manager such as the calls priority manager 270. One or more of the widgets 310 may present multimedia content in a multimedia section 310_M and/or textual content in a textual section 310_T. For example, a widget 310_1 estimated by the calls priority manager 270 as a kidnap event may include a multimedia section 310_1M and a textual section 310_1T. In another example, a widget 310_2 estimated by the calls priority manager 270 as a purse theft may include a multimedia section 310_2M and a textual section 310_2T. In another example, a widget 310_3 estimated by the calls priority manager 270 as a house fire may include a multimedia section 310_3M and a textual section 310_3T. In another example, a widget 310_4 estimated by the calls priority manager 270 as resuscitation conducted by a first person to a second person may include a multimedia section 310_4M and a textual section 310_4T. In another example, a widget 310_5 estimated by the calls priority manager 270 as a car accident with wounded may include a multimedia section 310_5M and a textual section 310_5T. In another example, a widget 310_6 estimated by the calls priority manager 270 as a car accident without wounded may include a multimedia section 310_6M and a textual section 310_6T.

Using the GUI, for example, interacting with the widget(s) in the unified digital dashboard, the dispatcher(s) 294 may access information relating to each of the potential emergency events estimated for each of the incoming emergency calls, for example, the multimedia content and/or the textual content. Based on the information the dispatcher(s) 294 may decide what action to take, which incoming emergency call to respond to, which emergency service (e.g. the police, the fire department, medical emergency service etc.) to direct the call to and/or the like.

Optionally, the widget created for one or more of the incoming emergency calls is maintained in the GUI presented on the display of the dispatch center client terminal(s) 290 after the respective incoming emergency call is accepted by one or more of the dispatchers 294. This may allow the dispatcher(s) 294 to access information provided by the widget(s) of the associated accepted incoming emergency call(s) during and/or after talking to the respective reporter 204 to get a better understanding of the nature of the emergency event and/or of the event characteristics.

It is expected that during the life of a patent maturing from this application many relevant systems, methods and computer programs will be developed and the scope of the terms peripheral devices, sensors and big data analytics tools are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A computer implemented method of prioritizing incoming emergency calls at a dispatch center, comprising:
using at least one processor for:
detecting at least one incoming emergency call from at least one client device;
before accepting the at least one incoming emergency call, acquiring via a communication network, sensory data captured by at least one sensor associated with the at least one client device and monitoring an environment of the at least one client device;
automatically analyzing the sensory data to identify at least one environment parameter deduced from the analysis;
prioritizing the at least one incoming emergency call in a queue comprising a plurality of incoming emergency calls concurrently received from a plurality of client devices according to the at least one environment parameter; and
adjusting a graphical user interface (GUI) presented on a display of at least one dispatch center client terminal according to the prioritization.

2. The computer implemented method of claim 1, wherein the at least one environment parameter is a member of a group consisting of: a parameter related to the at least one client device, a parameter related to a user of the at least one client device, a parameter related to interaction between the user and the at least one client device and a parameter related to a surroundings of the at least one client device.

3. The computer implemented method of claim 1, wherein the at least one sensor is a member of a group consisting of: an imaging sensor, an audio sensor, a geolocation sensor, a motion sensor and a physical condition sensor monitoring a user of the at least one client device.

4. The computer implemented method of claim 1, wherein the at least one sensor is integrated in the at least one client device.

5. The computer implemented method of claim 1, further comprising the at least one sensor is integrated in at least one another peripheral device associated with a user of the at least one client device and operatively communicating with the at least one client device through at least one communication channel.

6. The computer implemented method of claim 1, further comprising the sensory data is continuously collected from the at least one sensor and stored by the at least one client device regardless of initiation of the at least one incoming emergency call.

7. The computer implemented method of claim 1, further comprising the at least one environment parameter is identified by the at least one client device.

8. The computer implemented method of claim 1, further comprising the prioritization is done according to identification data acquired from the at least one client device in conjunction with the sensory data, the identification data comprising at least one member of a group consisting of: an age of a user of the at least one client device, a gender of the user, a name of the user, a telephone number associated with the at last one client device and an indication of a destination of the at least one incoming emergency call.

9. The computer implemented method of claim 8, further comprising the prioritization is done based on comparison of at least some of the identification data with stored identification data collected during at least one previous emergency call.

10. The computer implemented method of claim 1, further comprising the prioritization is done according to a prioritization model mapping a value of the at least one environment parameter to an emergency condition urgency level based on an analysis of a plurality of previous incoming emergency calls with respect to the at least one environment parameter associated with each of the plurality of previous incoming emergency.

11. The computer implemented method of claim 1, wherein the GUI is adjusted to present the queue in an order defined by the prioritization.

12. The computer implemented method of claim 1, wherein the GUI is adjusted to accentuate at least one visual indication associated with at least one of the incoming emergency call according to the prioritization.

13. The computer implemented method of claim 1, further comprising adjusting the GUI to present at least one widget associated with the at least one incoming emergency call, the at least one widget comprising a representation of at least some of the sensory data associated with the at least one incoming emergency call and identification data acquired from the at least one client device.

14. The computer implemented method of claim 13, further comprising adjusting the GUI to present a unified digital dashboard comprising the at least one widget.

15. The computer implemented method of claim 14, further comprising adjusting the GUI to present the unified digital dashboard comprising a plurality of widgets associated with at least some of the plurality of incoming emergency calls.

16. The computer implemented method of claim 13, further comprising maintaining the GUI to present the at least one widget after the at least one incoming emergency call is accepted.

17. The computer implemented method of claim 1, further comprising automatically correlating between a subset of the plurality of incoming emergency calls according to a geolocation identified for each of the incoming emergency calls of the subset based on the analysis of the sensory data acquired from the respective client devices.

18. The computer implemented method of claim 17, further comprising adjusting the GUI to present a correlation between a plurality of visual indications each associated with a respective incoming emergency call of the subset.

19. A system for prioritizing incoming emergency calls at a dispatch center, comprising:
a program store storing a code; and
at least one processor coupled to the program store for executing the stored code, the code comprising:
code instructions to detect at least one incoming emergency call from at least one client device;
code instructions to, before accepting the at least one incoming emergency call, acquire sensory data captured by at least one sensor associated with the at least one client device and monitoring an environment of the at least one client device;
code instructions to automatically analyze the sensory data to identify at least one environment parameter deduced from the analysis;
code instructions to prioritize the at least one incoming emergency call in a queue comprising a plurality of incoming emergency calls concurrently received from a plurality of client devices according to the at least one environment parameter; and
code instructions to adjust a graphical user interface (GUI) presented on a display of at least one dispatch center client terminal according to the prioritization.

20. A computer implemented method of generating a unified digital dashboard presented on a display of one or more dispatch center client terminals, comprising:
using at least one processor for:
receiving a plurality of sensory data sets from a plurality of client devices from which a plurality of incoming emergency calls are received, each of the plurality of sensory data sets comprises multimedia content consisting of at least one of imagery data, video data and audio data captured by one or more sensors associated with a respective one of the plurality of client devices;
generating a unified digital dashboard comprising at least one widget created for at least one of the plurality of incoming emergency calls, the at least one widget presenting the multimedia content received from a respective client device from which the at least one incoming emergency call is received; and
adjusting a graphical user interface (GUI) presented on a display of at least one dispatch center client terminal to present the unified digital dashboard.
